(19) United States
(12) Patent Application Publication
(10) Pub. No.: US 2025/0069198 A1
(43) Pub. Date: Feb. 27, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: HITOSHI FUKAMACHI, Kanagawa (JP); SHO SAITO, Saitama (JP); MASAHIRO MATSUSHITA, Kanagawa (JP); HAJIME MUTA, Kanagawa (JP); SHOZO YOSHIMURA, Kanagawa (JP)

(21) Appl. No.: 18/802,283

(22) Filed: Aug. 13, 2024

(30) Foreign Application Priority Data
Aug. 24, 2023 (JP) 2023-136285

(51) Int. Cl. G06T 5/60; G06V 10/98

(52) U.S. Cl. CPC G06T 5/60; G06V 10/993; G06T 2207/20084

(57) ABSTRACT

A restored image in which degradation in an image quality has been sufficiently reduced is generated. An image processing apparatus which generates a data of a restored image to be obtained by reducing degradation in an image quality contained in an input image by a method of inference using a neural network, according to the present disclosure, estimates a degree of the degradation in the image quality contained in the input image, and determines an adjustment parameter to be used in image restoration processing of reducing the degradation in the image quality, based on the estimated degree of the degradation in the image quality.

### BACKGROUND

### Field

The present disclosure relates to a technique of generating an image in which degradation in image quality has been reduced from an image having degraded image quality.

### Description of the Related Art

There are techniques of restoring an image from an image having degraded image quality (hereinafter referred to as “degraded image”) by using a deep neural network (hereinafter stated as “DNN”). DNN refers to a neural network composed of two or more hidden layers, and it is expected that the performance would be improved by increasing the number of hidden layers. Factors of degradation in the image quality include noise, blur, low resolution, missing data, and the like, and processing of reducing degradation in the image quality, that is, processing of restoring an image (hereinafter referred to as “image restoration processing”) includes noise reduction, deblurring, super-resolution, missing data complement, and the like. Degradation in the image quality can be caused by an image-capturing time, an image-capturing condition, or the like. For example, the SN ratio is lowered by a reduction of the number of photons entering light-receiving elements of an image sensor due to a change in brightness of the surrounding, a change in shutter speed, or the like, resulting in a captured image to which noise has been added (degraded image).

Japanese Patent Laid-Open No. 2023-47600 discloses an approach which generates a feature map representing an intensity of image restoration processing corresponding to each input image in a DNN and multiplying each pixel value of the generated feature map by a given coefficient, as a technique of adjusting an intensity of image restoration processing for each input image. According to the approach disclosed in Japanese Patent Laid-Open No. 2023-47600, an intensity of the image restoration processing can be adjusted for each input image at the time of generating an image in which degradation in the image quality has been reduced (hereinafter referred to as a “restored image”), by multiplying each pixel value of the generated feature map by a given coefficient.

### SUMMARY

An image processing apparatus which generates data of a restored image to be obtained by reducing degradation in an image quality contained in an input image by a method of inference using a neural network, according to the present disclosure, comprises: one or more hardware processors; and one or more memories storing one or more programs configured to be executed by the one or more hardware processors, the one or more programs including instructions for: estimating a degree of the degradation in the image quality contained in the input image; and determining an adjustment parameter to be used in image restoration processing for reducing the degradation in the image quality, based on the estimated degree of the degradation in the image quality.

Further features of the present disclosure will become apparent from the following description of exemplary embodiments with reference to the attached drawings.

### BRIEF DESCRIPTION OF THE DRAWINGS

FIG. 1 is a block diagram showing an example of a configuration of an image processing system according to Embodiment 1;

FIG. 2 is a block diagram showing an example of each functional configuration in the image processing apparatus and an information processing apparatus according to Embodiment 1;

FIG. 3 is a flowchart showing an example of a flow of processing in the information processing apparatus according to Embodiment 1;

FIG. 4 is a flowchart showing an example of a flow of processing in the image processing apparatus according to Embodiment 1;

FIG. 5A is a flowchart showing an example of a flow of estimation processing of a noise amount according to Embodiment 1, and FIG. 5B is a flowchart showing an example of a flow of determination processing of a noise amount according to Embodiment 1; and

FIG. 6 is a diagram showing an example of a UI screen according to Embodiment 2.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

In the conventional method, there has been a case where a restored image in which degradation in the image quality has been sufficiently reduced cannot be generated by merely multiplying each pixel value of a generated feature map by a given coefficient. In view of this, an object of the present disclosure is to provide a technique capable of generating a restored image in which degradation in the image quality has been sufficiently reduced.

### <About CNN>

Before each embodiment is described, a convolutional neural network (hereinafter described as “CNN”) which is used in general in image processing techniques employing deep learning will be described. A CNN conducts non-linear operation processing after convoluting a filter, which is generated as a result of learning, on image data and repeats this convolution processing and the non-linear operation processing. The filter is also called a local receptive field. An image obtained by conducting the non-linear operation processing after convoluting the filter on image data is called a feature map. Learning of a CNN is conducted by using learning data including a set of input image data and ground truth image data as output image data (hereinafter referred to as “training image data”). To put it simply, learning of a CNN is to generate, from learning data, a filter value capable of converting input image data into output image data corresponding to the input image data with high precision. The detail of the learning of a CNN will be described later.

In the case where input image data includes a plurality of color channels such as R (Red), G (Green), and B (Blue) or in the case where a feature map is composed of a plurality of images, the filter used in convolution processing also includes a plurality of channels in accordance with the number of color channels. That is, the filter used in the convolution processing is expressed by using a 4-dimensional array including the number of channels in addition to the vertical and horizontal sizes of images and the number of feature maps. The non-linear operation processing after convolution conducted on image data including feature maps is represented in unit of layer, and is expressed, for example, like an nth (n is an integer of 1 or more)-layer feature map, an nth-layer filter, and the like. For example, a CNN which repeats convolution using filters and non-linear operation processing three times has a three-layer network structure. Such non-linear operation processing can be formulated by using the following formula (1), for example.

$${X}_{n}^{( 1 )} = f ( {\sum }_{n = 1}^{N} {W}_{n}^{( 1 )} * {X}_{n - 1}^{( 1 )} + {b}_{n}^{( 1 )} ) \qquad formula ( 1 )$$

Here, Wₙ is the nth-layer filter, bₙ is the nth-layer bias, f is the non-linear operator, Xₙ is the nth-layer feature map, and * is the convolution operator. Note that (1) on the right shoulder indicates that the filter or feature map is the lth one. The filters and biases are generated by learning, which will be described later, and are also referred to collectively as “network parameters”. A sigmoid function, a ReLU (Rectified Linear Unit), or the like, is used as the non-linear operation processing. In the case where ReLU is used as the non-linear operation processing, the non-linear operator f is given by using the following formula (2), for example.

$$f ( X ) = \{ \begin{matrix}X & if 0 \leq X \\ 0 & otherwise\end{matrix} \} \qquad formula ( 2 )$$

As expressed by the formula (2), for negative components among elements of the vector X inputted to the non-linear operator f, 0 is outputted, while for components of 0 or more, these values are outputted as they are. As neural networks using CNNs, ResNet in the field of image recognition, RED-Net utilizing ResNet in the field of super-resolution, and the like are known. Any of these neural networks is capable of achieving processing with high precision by making CNNs multi-layered and conducting convolution of filters many times. For example, ResNet is characterized by a network structure provided with paths for shortcutting processing of one or more convolution layers. This makes it possible to achieve a multi-layer network having as many as 152 layers and achieve high precision recognition close to the recognition rates of humans. Note that to put it simply, the reason why processing having high precision can be achieved by making a CNN with a multi-layer network is that a non-linear relationship between input and output can be expressed by repeating non-linear operation processing many times.

### <Learning of CNN>

The learning of a CNN will be described. The learning of a CNN is generally conducted by minimizing an objective variable of a loss function expressed by the following formula (3) with respect to learning data including pairs of input image (also referred to as “test image”) data and training image data corresponding to the test image data.

$$L ( θ ) = \frac{1}{n} {\sum }_{i = 1}^{n} {‖ F ( {X}_{i} ; θ ) - {Y}_{i} ‖}_{2}^{2} \qquad formula ( 3 )$$

Here, L is a loss function for measuring an error between a result of inference of the CNN on an input and a ground truth corresponding to the input. In addition, Yᵢ is the ith training image data, and Xᵢ is the ith input image (test image) data. F is a function collectively expressing the operation shown in the formula (1) as an example, which is performed in each layer of the CNN. θ is a network parameter (filter and bias). ∥Z∥₂ is the L2 norm, or to put it simply, the square root of the sum of the squares of the components of a vector Z. n is the total number of pieces of learning data used in the learning.

In general, since the total number of pieces of learning data is huge, in stochastic gradient descent, some of the pieces of learning image data is selected at random, and the learning is conducted by using the selected pieces of learning data. This makes it possible to reduce a computation load in the learning using a huge amount of learning data. In addition, as a method for minimizing, that is, optimizing an objective variable in a loss function, various methods such as the momentum method, the AdaGrad method, the AdaDelta method, and the Adam method are known, and for example, the Adam method is given by using a series of formulas expressed by the following formulas (4) to (7).

$$g = \frac{\partial L}{\partial {θ}_{i}^{t}} \qquad formula ( 4 )$$

$$m = {β}_{1} m + ( 1 - {β}_{1} ) g \qquad formula ( 5 )$$

$$v = {β}_{2} v + ( 1 - {β}_{2} ) {g}^{2} \qquad formula ( 6 )$$

$${θ}_{i}^{t + l} = {θ}_{i}^{t} - α \frac{\sqrt{1 - {β}_{2}^{t}}}{( 1 - {β}_{1} )} \frac{m}{( \sqrt{v} + ϵε )} \qquad formula ( 7 )$$

Here, θᵢ^{t} is the ith network parameter at the tth repetition, and g is the gradient of the loss function L for θᵢ^{t}. m and v are moment vectors, a is the base learning rate, β₁ and β₂ are hyperparameters, and ε is a small constant. Note that since there is no selection indicator on the optimization methods for learning, basically any method can be used. However, it is known that methods have different convergences and thus differences in learning time are generated.

### Embodiment 1

In the present embodiment, a method including estimating an intensity of degradation in an image quality in an input image, and adjusting an intensity of image restoration processing on the input image based on a result of estimation without changing a network configuration of a CNN will be described. Note that in the present embodiment, the case where noise, which is one of factors of degradation in the image quality, is contained in an input image will be described as an example.

### Example of Configuration of Image Processing System

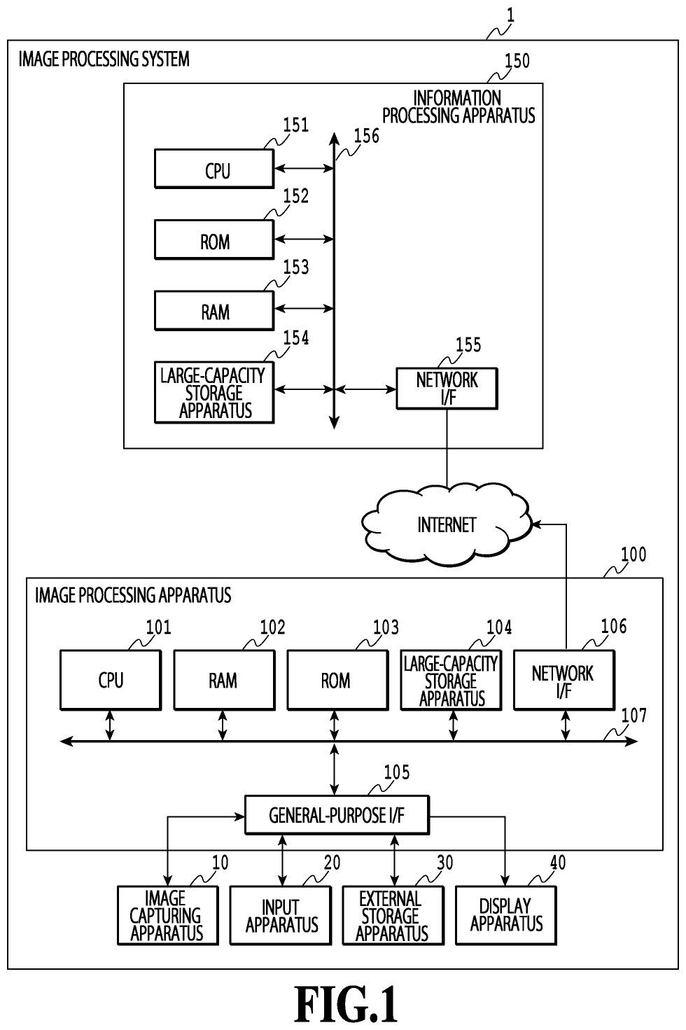

FIG. 1 is a block diagram showing an example of a configuration of an image processing system 1 according to Embodiment 1. The image processing system 1 includes an image processing apparatus 100, an image capturing apparatus 10, an input apparatus 20, an external storage apparatus 30, a display apparatus 40, and an information processing apparatus 150, and the image processing apparatus 100 and the information processing apparatus 150 are communicatively connected to one another via the Internet. The information processing apparatus 150 conducts to generate learning data and to learn of a learning model to achieve image restoration processing (hereinafter referred to as “degradation restoration learning”)). The image processing apparatus 100 conducts inference processing on a restored image (hereinafter referred to as “degradation restoration inference”) by using a weight parameter of a learned model obtained as a result of the degradation restoration learning, that is, a learned neural network to generate restored image data.

### <Hardware Configuration of Image Processing Apparatus>

The image processing apparatus 100 is configured with a personal computer or the like, obtains captured image data outputted by the image capturing apparatus 10, and generates data of a restored image corresponding to the captured image data. Here, the captured image data is, for example, RAW image data obtained by using a Bayer array or the like. Specifically, the image processing apparatus 100 generates a restored image by applying a weight parameter of a learned neural network provided from the information processing apparatus 150 to captured image data to conduct inference processing for degradation restoration. The user can generate data of a restored image corresponding to captured image data by utilizing image processing application software installed on the image processing apparatus 100.

The image processing apparatus 100 includes a CPU 101, a RAM 102, a ROM 103, a large-capacity storage apparatus 104, a general-purpose I/F 105, and a network I/F 106, and the constituent elements are communicatively connected to one another via a system bus 107. In addition, the image processing apparatus 100 is communicatively connected to the image capturing apparatus 10, the input apparatus 20, the external storage apparatus 30, and the display apparatus 40 via the general-purpose I/F 105.

The CPU 101 executes programs stored in the ROM 103 by using the RAM 102 as a work memory to control the constituent elements of the image processing apparatus 100 via the system bus 107 overall. The large-capacity storage apparatus 104 is configured with, for example, a hard disk drive, a solid-state drive, or the like and stores various data to be handled in the image processing apparatus 100, and the like. The CPU 101 writes data into the large-capacity storage apparatus 104 and reads data stored in the large-capacity storage apparatus 104 via the system bus 107. The general-purpose I/F 105 is, for example, a serial bus interface such as USB (Universal Serial Bus), IEEE 1394, HDMI (registered trademark) (High-Definition Multimedia Interface (registered trademark)), or the like.

The image processing apparatus 100 obtains data from the external storage apparatus 30 configured with any of various storage media such as a memory card, a CF (CompactFlash (registered trademark)) card, a SD (registered trademark) card, or a USB memory via the general-purpose I/F 105. In addition, the image processing apparatus 100 receives user instructions from the input apparatus 20 such as a mouse or a keyboard via the general-purpose I/F 105. In addition, the image processing apparatus 100 outputs image data processed by the CPU 101, and the like to the display apparatus 40 configured with any of various image display devices such as a liquid-crystal display via the general-purpose I/F 105. In addition, the image processing apparatus 100 obtains captured image data to be a target for the degradation restoration inference from the image capturing apparatus 10 via the general-purpose I/F 105. The network I/F 106 is an interface for connecting to the Internet. The image processing apparatus 100 accesses the information processing apparatus 150 via an installed web browser or the like to obtain a weight parameter of a learned neural network for the degradation restoration inference.

### <Hardware Configuration of Information Processing Apparatus>

The information processing apparatus 150 is configured with a server apparatus or the like. The information processing apparatus 150 may be configured with a cloud server in which a plurality of server apparatuses cooperate with one another. The information processing apparatus 150 includes a CPU 151, a ROM 152, a RAM 153, a large-capacity storage apparatus 154, and a network I/F 155, and the constituent elements are communicatively connected to one another via a system bus 156. The CPU 151 reads control programs stored in the ROM 152 and executes various processing by using the RAM 153 as a work memory to control the operation of the entire information processing apparatus 150. The RAM 153 is used as a temporary storage area such as a main memory and a work area for the CPU 151. The large-capacity storage apparatus 154 is configured with, for example, a hard disk drive or the like and stores image data, various programs, and the like. The network I/F 155 is an interface for connecting to the Internet. In response to a request from the image processing apparatus 100, the information processing apparatus 150 outputs a weight parameter of a learned neural network for the degradation restoration inference processing to the image processing apparatus 100.

Note that there are other constituent elements of the image processing apparatus 100 and the information processing apparatus 150 than the above-mentioned configurations; however those are not main points of the present disclosure and will not be described. In addition, Embodiment 1 will be described on the premise that generation of learning data and degradation restoration learning are conducted in the information processing apparatus 150 and a learned model, which is a result of the learning, is outputted to the image processing apparatus 100, and degradation restoration inference on captured image data is conducted in the image processing apparatus 100. However, such an aspect is mere an example, and the configuration is not limited to this. For example, a configuration is possible in which the functions achieved by the information processing apparatus 150 are segmentalized and the generation of learning data and the degradation restoration learning are conducted by different apparatuses. In addition, for example, a configuration is possible in which all the generation of learning data, the degradation restoration learning, and the degradation restoration inference are conducted in an apparatus such as the image capturing apparatus 10 that has both of the functions of the image processing apparatus 100 and the functions of the information processing apparatus 150.

### <Functional Configurations of Image Processing System>

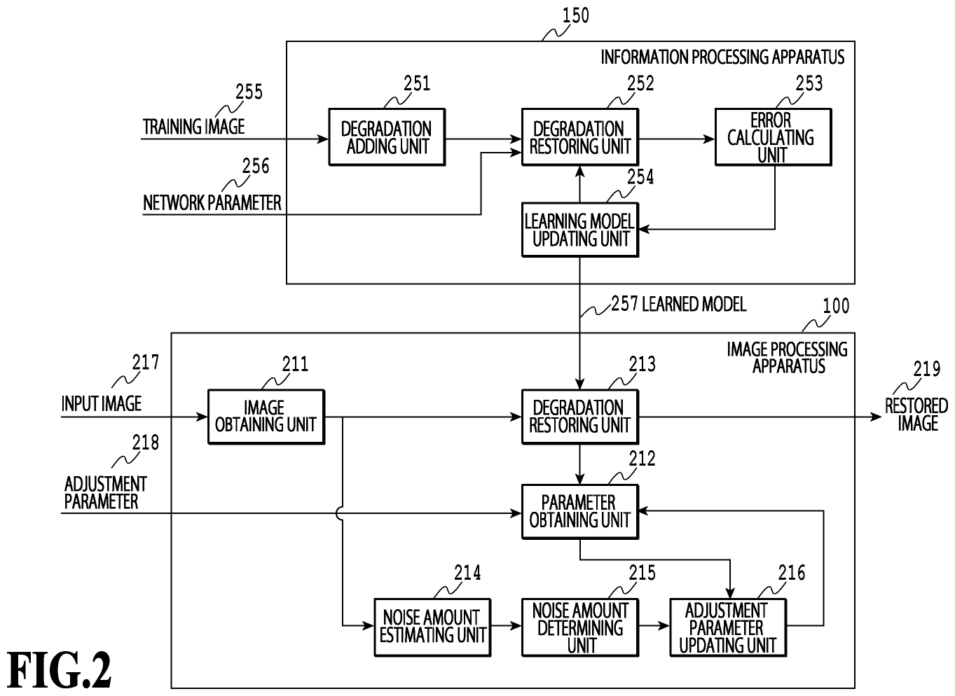

FIG. 2 is a block diagram showing an example of each functional configuration in the image processing apparatus 100 and the information processing apparatus 150 included in the image processing system 1 according to Embodiment 1. The image processing apparatus 100 includes, as the functional configurations, an image obtaining unit 211, a parameter obtaining unit 212, a degradation restoring unit 213, a noise amount estimating unit 214, a noise amount determining unit 215, and an adjustment parameter updating unit 216. In addition, the information processing apparatus 150 includes, as the functional configurations, a degradation adding unit 251, a degradation restoring unit 252, an error calculating unit 253, and a learning model updating unit 254. Note that the functional configurations shown in FIG. 2 may be modified or changed as appropriate. For example, one functional unit may be divided into a plurality of functional units, or two or more functional units may be integrated into one functional unit. In addition, the functional configurations shown in FIG. 2 may be achieved by using two or more apparatuses. In this case, the apparatuses are connected via a circuit, or a wired or wireless network, and cooperate and operate with each other while communicating data with each other to achieve processing in each functional unit, which will be described later.

### <Example of Application of Image Processing System>

Hereinafter, the case of applying the image processing system 1 to real-time monitoring will be described as an example. In real-time monitoring, captured image data obtained by image capturing of the image capturing apparatus 10 is transmitted from the image capturing apparatus 10 to the image processing apparatus 100 in order of time series. The degradation restoring unit 213 conducts the image restoration inference on the time-series captured image data, which has been received by the image processing apparatus 100, by using an adjustment parameter, which has been obtained by the parameter obtaining unit 212. A restored image 119 generated through the image restoration inference is displayed on the display apparatus 40, which allows the user to conduct the real-time monitoring. Here, the adjustment parameter may be a value set in advance or may be a value updated at a timing desired by the user.

Depending on differences in image-capturing time or image-capturing condition, or the like, for example, a noise amount added to a captured image varies between image capturing in a bright scene such as during a daytime or in an indoor scene where lighting is on, or the like and image capturing in a dark scene such as during a night-time or in an indoor scene where lighting is off, or the like. In the case where an adjustment parameter corresponding to this varying noise amount is not properly set, the amount of reduction of noise becomes insufficient or excessive in the image restoration in the degradation restoring unit 113. This causes a possibility that data of a proper restored image in which degradation in the image quality has been sufficiently reduced is not generated. In addition, in the case where the user manually updates an adjustment parameter in accordance with a change in noise amount of a captured image, the user incurs a burden of setting the adjustment parameter. The image processing apparatus 100 automatically updates an adjustment parameter in accordance with a change in degradation in the image quality in a captured image. The processing of each functional unit included in the image processing apparatus 100 and flows of processing in the image processing apparatus 100 will be described later.

### <Processing of Each Functional Unit Included in Information Processing Apparatus>

The processing of each functional unit included in the information processing apparatus 150 will be described. The degradation adding unit 251 obtains data of a training image 255 and adds noise, which is one of factors of degradation in the image quality, to the data of the training image 255 thus obtained, to generate data of a test image. An image data pair including data of the training image 255 and data of the test image is used as learning data in learning of a learning model, which will be described later. The learning data is inputted to the degradation restoring unit 252 and the error calculating unit 253. The training image 255 can include various types of images such as a photograph of nature in which a scenery or a living organism is a subject and a photograph of a person in which a person in a portrait or a sporting event is a subject. The training image 255 is not limited to the above-mentioned ones, and the training image 255 may include, for example, an image such as a photograph of an artificial object in which an artificial object such as a structure or a product is a subject. In addition, the training image 255 can include a plurality of images each having brightness different from the others. Hereinafter, description is made on the premise that data of the training image 255 is RAW image data in which each pixel has a pixel value corresponding to at least one color among R, G, and B as an example.

The degradation restoring unit 252 conducts the degradation restoration learning by using learning data generated by the degradation adding unit 251. Specifically, first, the degradation restoring unit 252 obtains a network parameter 256 and initializes weight parameters of the CNN to be a target for the degradation restoration learning by using the obtained network parameter 256. Subsequently, the degradation restoring unit 252 receives learning data from the degradation adding unit 251, inputs test image data contained in the learning data into the CNN, and repeats the convolution operation using the filter and the non-linear operation in accordance with the formulas (1) and (2) multiple times. Data of a restored image is generated by repetition of these operations. The data of the restored image thus generated is inputted to the error calculating unit 253. The error calculating unit 253 obtains the data of the training image 255 contained in the learning data and the data of the restored image and calculates an error between the data of the training image 255 and the data of the restored image in accordance with the formula (3). The learning model updating unit 254 updates the weight parameters in the CNN such that the error calculated in the error calculating unit 253 becomes smaller. The detail of the CNN and the flow of the processing in the information processing apparatus 150 according to the present embodiment will be described later.

### <Processing of Each Functional Unit Included in Image Processing Apparatus>

The processing of each functional unit included in the image processing apparatus 100 will be described. The image obtaining unit 211 sequentially obtains captured image data obtained by image capturing by the image capturing apparatus 10 as data of an input image 217 in order of time series. The data of the input image 217 obtained by the image obtaining unit 211 is inputted into the degradation restoring unit 213 and the noise amount estimating unit 214. Hereinafter, description is made on the premise that the data of the input image 217 is RAW image data in which each pixel has a pixel value corresponding to at least one color among R, G, and B as an example. In addition, hereinafter, the description is made on the premise that RAW image data is image data obtained by image capturing using a color filter of the Bayer array in which each pixel has information of one color.

The parameter obtaining unit 212 obtains an adjustment parameter for adjusting an intensity of image restoration processing (hereinafter referred to as “degradation restoration intensity”). In addition, the parameter obtaining unit 212 holds the obtained adjustment parameter until obtaining a new adjustment parameter, and deletes the adjustment parameter obtained previously when obtaining a new adjustment parameter. For example, the parameter obtaining unit 212 obtains an adjustment parameter 118 from an external apparatus, which is not shown in FIG. 1 and FIG. 2, or through an input operation by the user, as an initial value of the adjustment parameter. Thereafter, the parameter obtaining unit 212 obtains an adjustment parameter outputted by the adjustment parameter updating unit 216, which will be described later, as a new adjustment parameter. The parameter obtaining unit 212 may obtain various other parameters to be used by the degradation restoring unit 213 in addition to the adjustment parameter.

Into the degradation restoring unit 213, the learned model outputted by the information processing apparatus 150, that is, the weight parameters of the learned CNN, the captured image data obtained by the image obtaining unit 211, and the adjustment parameter obtained by the parameter obtaining unit 212 are inputted. The degradation restoring unit 213 conducts the degradation restoration inference on the captured image data inputted as the data of the input image 217 by using the inputted information. Specifically, the degradation restoring unit 213 inputs the captured image data obtained by the image obtaining unit 211 into the learned model 257 and repeats the convolution operation using the filter and the non-linear operation in accordance with the formulas (1) and (2) multiple times. Then, the degradation restoring unit 213 generates data of a restored image 219 by using the adjustment parameter held by the parameter obtaining unit 212.

More specifically, the adjustment parameter is a coefficient α which is used in processing each pixel, and the degradation restoration intensity is adjusted by multiplying each pixel value in a feature map obtained as a result of the filter operation by the coefficient α. In the case where the coefficient α is larger than 1, the intensity of the image restoration processing on the data of the input image becomes large. Conversely, in the case where the coefficient α is smaller than 1, the intensity of the image restoration processing on the data of the input image 217 becomes small. The degradation restoring unit 213 outputs data of the restored image 219 thus generated to the external storage apparatus 30 or the display apparatus 40, for example.

Here, the CNN used as a learning model according to Embodiment 1 will be described. The CNN according to Embodiment 1 includes one or more layers (hereinafter referred to as “map generating layers”) for generating a feature map representing the intensity of the image restoration processing on inputted image data. In addition, the CNN according to Embodiment 1 includes one or more layers (hereinafter referred to as “intensity adjusting layers”) for adjusting the degradation restoration intensity by multiplying each pixel value in a generated feature map by the coefficient α, that is, an adjustment parameter. Moreover, the CNN according to Embodiment 1 includes one or more layers (hereinafter referred to as “image generating layers”) for generating data of a restored image 219 corresponding to data of an input image 217 based on the feature map after each pixel value has been multiplied by the coefficient α.

The degradation restoration learning in the information processing apparatus 150 is conducted in a state where the adjustment parameter, which is the weight parameter in the intensity adjusting layer, is fixed to a predetermined positive real number such as “1.0”, for example. In this case, in the degradation restoration learning in the information processing apparatus 150, the adjustment parameter, which is the weight parameter in the intensity adjusting layer, is fixed, and the weight parameters of the map generating layer and the image generating layer are updated. In the degradation restoration inference in the image processing apparatus 100, an adjustment parameter held by the parameter obtaining unit 212 is plugged in the adjustment parameter, which is the weight parameter in the intensity adjusting layer, in a learned model obtained as a result of the degradation restoration learning in the information processing apparatus 150. By such plugging, it is possible to adjust the degradation restoration intensity without changing the network configuration of the CNN.

The noise amount estimating unit 214 sequentially receives the captured image data (data of the input image 217) obtained by the image obtaining unit 211 and sequentially stores the captured image data thus received in the RAM 102 or the like. Hereinafter, a plurality of pieces of captured image data which the noise amount estimating unit 214 sequentially stores in the RAM 102 or the like are referred to as a captured image data group. The noise amount estimating unit 214 estimates a noise amount in captured image data included in the captured image data group at a predetermined timing. Specifically, for example, the noise amount estimating unit 214 estimates a noise amount for each piece of captured image data included in the captured image data group. Note that the method for estimating a noise amount in captured image data will be described later. A result of estimating a noise amount in each of the plurality of pieces of captured image data by the noise amount estimating unit 214 is outputted to the noise amount determining unit 215.

The noise amount determining unit 215 determines a noise amount based on the result of estimating a noise amount in each of the plurality of pieces of captured image data by the noise amount estimating unit 214. Specifically, the noise amount determining unit 215 determines a noise amount based on a statistic of the results of estimating noise amounts in the plurality of pieces of captured image data of time-series. In addition, the noise amount determining unit 215 determines an adjustment parameter corresponding to the determined noise amount and outputs the determined adjustment parameter to the adjustment parameter updating unit 216. Note that the method for determining a noise amount, and the method for determining an adjustment parameter corresponding to the determined noise amount will be described later.

The adjustment parameter updating unit 216 judges whether or not the current adjustment parameter held by the parameter obtaining unit 212 and the new adjustment parameter determined by the noise amount determining unit 215 have values different from each other. In the case where the current adjustment parameter and the new adjustment parameter have values different from each other, the adjustment parameter updating unit 216 outputs the new adjustment parameter to the parameter obtaining unit 212, and the parameter obtaining unit 212 obtains this. In this way, the adjustment parameter held by the parameter obtaining unit 212 is updated.

### <Processing Flow of Information Processing Apparatus>

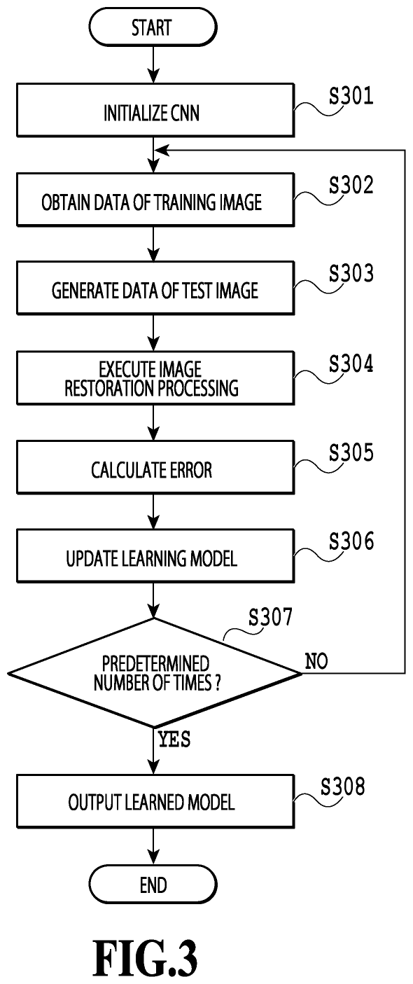

An operation of the information processing apparatus 150 will be described with reference to FIG. 3. FIG. 3 is a flowchart showing an example of a flow of processing in the information processing apparatus 150 according to Embodiment 1. Note that the CPU 151 reads programs for implementing the processing of the flowchart shown in FIG. 3 from the large-capacity storage apparatus 154 or the like and executes the programs to achieve the functions of the above-mentioned respective units which the information processing apparatus 150 includes as functional configurations. In the following description, mark “S” means a step.

First, in S301, the degradation restoring unit 252 obtains a network parameter 256 and initializes weight parameters of a CNN to be the target for the degradation restoration learning by using the obtained network parameter 256. Note that the CNN is a DNN including the map generating layer, the intensity adjusting layer, and the image generating layer as mentioned above. Next, in S302, the degradation adding unit 251 obtains data of a training image 255. Next, in S303, the degradation adding unit 251 adds noise to the data of the training image 255 obtained in S302 to generate data of a test image. Next, in S304, the degradation restoring unit 252 inputs the test image data generated in S303 into the CNN to execute the image restoration processing on the test image data. Next, in S305, the error calculating unit 253 calculates an error between the data of the training image 255 obtained in S302 and data of a restored image outputted as a result of the image restoration processing in S304.

Next, in S306, the learning model updating unit 254 updates the weight parameters in the CNN such that the error calculated in S305 becomes smaller. Here, the learning model updating unit 254 fixes the weight parameter of a layer corresponding to the intensity adjusting layer and updates only the weight parameters of layers corresponding to the map generating layer and the image generating layer, among the weight parameters of the respective layers in the CNN. Next, in S307, the learning model updating unit 254 judges whether or not a predetermined number of times of updating on the weight parameters in the CNN, that is, a predetermined number of times of learning on the CNN has been conducted. If it is judged that the predetermined number of times of updating (learning) has not been conducted in S307, the information processing apparatus 150 repeatedly executes the processing from S302 to S307 until it is judged that the predetermined number of times of updating (learning) has been conducted in S307. If it is judged that the predetermined number of times of updating (learning) has been conducted in S307, in S308, the learning model updating unit 254 outputs the weight parameters of the learned CNN, which is a learned model 257, to the image processing apparatus 100. After S308, the information processing apparatus 150 ends the processing of the flowchart shown in FIG. 3.

### <Processing Flow of Image Processing Apparatus 100>

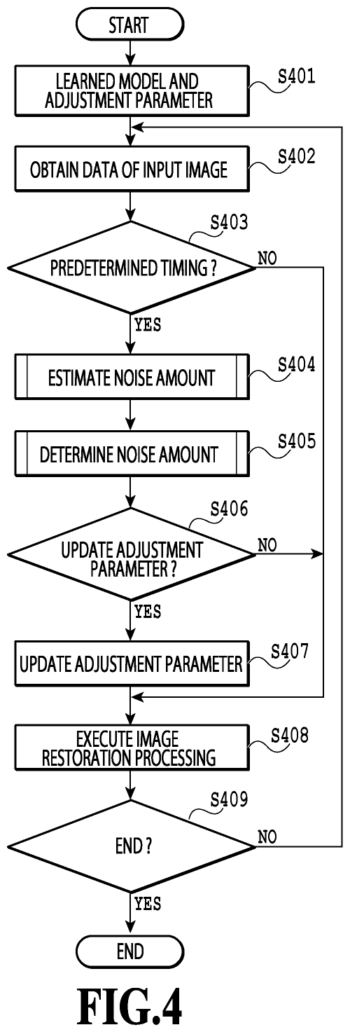

An operation of the image processing apparatus 100 will be described with reference to FIG. 4. FIG. 4 is a flowchart showing an example of a flow of processing in the image processing apparatus 100 according to Embodiment 1. The processing of the flowchart shown in FIG. 4 is initiated by turning on the power of the image processing apparatus 100 and receiving an input of captured image data from the image capturing apparatus 10. Note that the CPU 101 reads programs for implementing the processing of the flowchart shown in FIG. 4 from the large-capacity storage apparatus 104 or the like and executes the programs to achieve the functions of the above-mentioned respective units which the image processing apparatus 100 includes as functional configurations.

First, in S401, the degradation restoring unit 213 obtains weight parameters of the learned CNN, which is the learned model, from the information processing apparatus 150 and develops the weight parameters in the RAM 102. In addition, in S401, the parameter obtaining unit 212 obtains an adjustment parameter 218. After S401, in S402, the image obtaining unit 211 obtains captured image data (data of an input image 217) outputted from the image capturing apparatus 10. The captured image data obtained in S402 is transmitted to the degradation restoring unit 213 and the noise amount estimating unit 214, and the degradation restoring unit 213 and the noise amount estimating unit 214 receive this.

Here, the noise amount estimating unit 214 sequentially stores and accumulates the captured image data received in S402 in the RAM 102 or the like. For example, the noise amount estimating unit 214 prepares an image buffer for sequentially accumulating the received captured image data in the RAM 102, and sequentially accumulates the received captured image data in the image buffer. Specifically, for example, in the case of accumulating data of 100 captured images, the noise amount estimating unit 214 sets captured image data received at a certain time point as data of the 1st captured image, and accumulates data of the 1st to 100th captured images in the image buffer in order of time series. In the case where the noise amount estimating unit 214 has received data of the 101st captured image, the noise amount estimating unit 214 deletes the data of the 1st captured image from the image buffer and stores the data of the 101st captured image next to the data of the 100th captured image. Preparing an image buffer having such a ring buffer configuration makes it possible for the noise amount estimating unit 214 to temporarily accumulate data of a predetermined number of captured images in the image buffer.

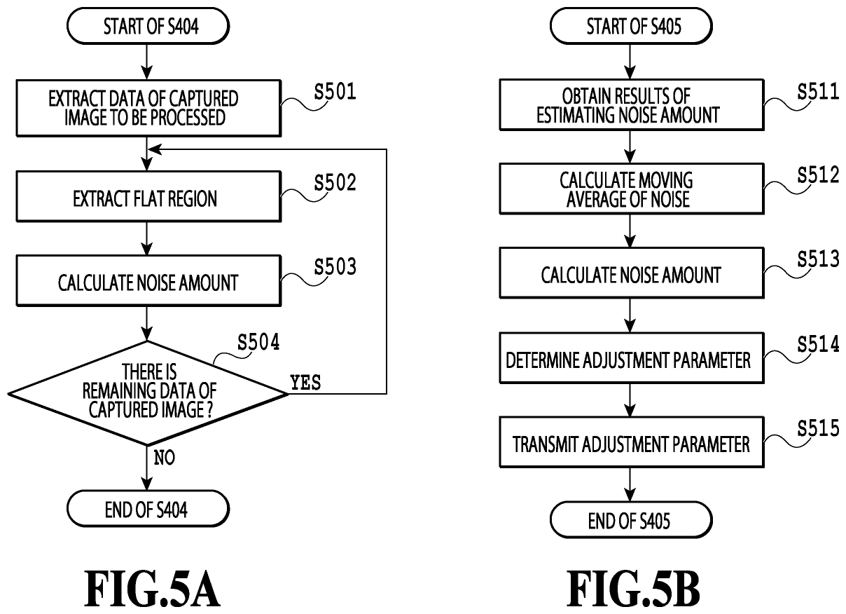

After S402, in S403, the noise amount estimating unit 214 judges whether or not a predetermined timing set in advance has been reached. If it is judged that the predetermined timing has been reached in S403, the image processing apparatus 100 executes processing of S404. If it is judged that the predetermined timing has not been reached in S403, the image processing apparatus 100 executes processing of S408. In S404, the noise amount estimating unit 214 estimates a noise amount in the captured image data accumulated in the image buffer in S402. The detail of the method for estimating a noise amount in S404 will be described later with reference to FIG. 5A. After S404, in S405, the noise amount determining unit 215 determines a noise amount at the above-mentioned predetermined timing based on the result of estimating a noise amount in each piece of the captured image data estimated in S404. Moreover, following S405, the noise amount determining unit 215 determines, based on the determined noise amount, a new adjustment parameter corresponding to the noise amount. Specifically, for example, the noise amount determining unit 215 holds a look-up table in which adjustment parameter values corresponding respectively to noise amounts have been estimated in advance, and determines an adjustment parameter value corresponding to the determined noise amount by referring to the look-up table. The detail of the method for determining a noise amount in S405 will be described later with reference to FIG. 5B.

After S405, in S406, the adjustment parameter updating unit 216 judges whether or not to update the existing adjustment parameter held by the parameter obtaining unit 212. For example, the adjustment parameter updating unit 216 compares the existing adjustment parameter held by the parameter obtaining unit 212 and the new adjustment parameter determined in S405 to judge whether or not the adjustment parameters have values different from each other. If the adjustment parameters have values different from each other, the adjustment parameter updating unit 216 judges to update the existing adjustment parameter held by the parameter obtaining unit 212 by using the new adjustment parameter determined in S405. If the adjustment parameters do not have values different from each other, that is, if the adjustment parameters are the same values, the adjustment parameter updating unit 216 judges not to update the existing adjustment parameter held by the parameter obtaining unit 212.

Note that the same values mentioned here are not limited to the completely same values but may include substantially same values. In addition, in this case, the case where the adjustment parameters are different from each other does not have to include a case where the difference between the adjustment parameters is within a predetermined range. If it is judged to update the existing adjustment parameter held by the parameter obtaining unit 212 in S406, the image processing apparatus 100 executes processing of S407. On the other hand, if it is judged not to update the existing adjustment parameter held by the parameter obtaining unit 212 in S406, the image processing apparatus 100 executes processing of S408.

If it is judged to update the existing adjustment parameter held by the parameter obtaining unit 212 in S406, in S407, the adjustment parameter updating unit 216 outputs the new adjustment parameter determined in S405 to the parameter obtaining unit 212. In S407, the parameter obtaining unit 212 obtains the new adjustment parameter outputted by the adjustment parameter updating unit 216 and updates the held existing adjustment parameter to the obtained new adjustment parameter. The new adjustment parameter after updating is held as an existing adjustment parameter in the parameter obtaining unit 212. After S407, the image processing apparatus 100 executes the processing of S408.

In S408, the degradation restoring unit 213 executes the image restoration processing by inputting the captured image data obtained in S402 into the learned model 257. Specifically, the degradation restoring unit 213 inputs the captured image data obtained in S402 into the CNN in which the adjustment parameter for adjusting the degradation restoration intensity, which is held by the parameter obtaining unit 212, has been inputted into the weight parameter in the intensity adjusting layer in the learned model 257. Data of a restored image 219 generated by the image restoration processing is transmitted to and displayed on the display apparatus 40, for example.

After S408, in S409, the image processing apparatus 100 judges whether or not to end the series of processing from S402 to S408. Specifically, for example, if the image obtaining unit 211 obtains new captured image data from the image capturing apparatus 10, the image processing apparatus 100 judges not to end the above-mentioned series of processing. In addition, if the image obtaining unit 211 does not obtain new captured image data from the image capturing apparatus 10 within a predetermined period of time, the image processing apparatus 100 judges to end the above-mentioned series of processing. If it is judged not to end the above-mentioned series of processing in S409, the image obtaining unit 211 returns to S402 and continues the above-mentioned series of processing until it is judged to end the above-mentioned series of processing in S409. On the other hand, if it is judged to end the above-mentioned series of processing in S409, the image obtaining unit 211 ends the processing of the flowchart shown in FIG. 4. Note that the judgment condition on whether or not to end in the processing of S409 is not limited to the presence or absence of an input of new captured image data from the image capturing apparatus 10, but for example, the image processing apparatus 100 may make the judgment based on an input of an instruction from the user.

### <Estimation Processing and Determination Processing of Noise Amount>

The details of the estimation processing of a noise amount in S404 and the determination processing of a noise amount in S405 will be described with reference to FIGS. 5A and 5B. FIG. 5A is a flowchart showing an example of a flow of processing of S404 in the noise amount estimating unit 214 according to Embodiment 1. First, in S501, the noise amount estimating unit 214 extracts captured image data to be the target for the estimation processing of a noise amount from among the captured image data group accumulated in the image buffer in S402. Specifically, for example, the noise amount estimating unit 214 determines captured image data to be the target to be extracted for the processing based on an execution timing set in advance and a used number of divisions set in advance.

Here, information indicating the execution timing is information indicating at what timing the noise amount estimating unit 214 executes the estimation processing of a noise amount. For example, in the case where data of 10 captured images are outputted per second from the image capturing apparatus 10 and the image obtaining unit 211 obtains this, the execution timing is set such that the noise amount estimating unit 214 executes the estimation processing of a noise amount once data of 10 captured images are newly accumulated in the image buffer. In this case, the interval of execution timings is 1 second, and the noise amount estimating unit 214 executes the estimation processing of a noise amount once per second. Setting the execution timing in this way makes it possible for the image processing apparatus 100 to adjust the degradation restoration intensity within the interval of execution timings at the latest in response to a change in image-capturing condition such as a change in brightness within an image-capturing range.

The interval of execution timings is not limited to a constant interval such as an interval of 1 second. For example, in the case where captured image data captured in a sufficiently bright environment such as during a daytime or in an interior where lighting is on is obtained, a noise amount to be added to the captured image is smaller than captured image data captured in a dark environment. For this reason, in such a case, the interval of execution timings can be set to be longer than the other cases on the premise that a change in noise amount in captured image data is smaller. On the other hand, during a period of time when the brightness of an image-capturing range changes every second like a period of time from the evening to the night-time, the noise amount of captured image data can change in accordance with a change in brightness. During such a period of time when the brightness changes every second, the degradation restoration intensity can be more promptly adjusted to follow a change in noise amount by shortening the interval of execution timings in the estimation processing of a noise amount as compared with the other periods of time.

In addition, the used number of divisions indicates the number of captured images in one set to be used in the case where the noise amount estimating unit 214 conducts the estimation processing of a noise amount. For example, in the case where the used number of divisions is 5, the noise amount estimating unit 214 sets data of 5 captured images in order of time series as one set among data of 10 captured images newly accumulated in the image buffer and extracts one of the two sets of data of captured images. The noise amount estimating unit 214 estimates a noise amount in the series of processing of S502 and S503, which will be described later, by using the set of captured image data extracted based on the used number of divisions set in advance. By setting data of a plurality of captured images as data of one set of captured images, it is possible to exclude an image region that has motion in captured images, that is, an image region that does not become flat temporally, in an extraction processing of a flat region in S502, which will be described later.

Note that in the present embodiment, it is assumed that the used number of divisions is set to 1 for the sake of simplifying the description. That is, in the following description, the noise amount estimating unit 214 is assumed to extract data of one captured image among data of a plurality of captured images newly accumulated in the image buffer in the processing of S501. Data of one captured image or a set of data of captured images extracted in S501 serves as data of a captured image to be the target for the processing in the series of processing of S503 and S504.

After S501, in S502, the noise amount estimating unit 214 analyzes captured image data extracted in S501 and extracts a flat image region (hereinafter referred to as “flat region”) in the captured image. A flat region is any image region in which a spatial variation of pixel values is small in a captured image. Specifically, for example, the noise amount estimating unit 214 analyzes pixel values of an image region of a surrounding s×t pixels including the coordinates (i,j) of an interest pixel in a captured image, and in the case where changes in pixel values of the image region are small, extracts this image region as a flat region. Here, each of i, j, s, and t is any integer of 0 or more. Hereinafter, a region other than a flat region in a captured image is referred to as a non-flat region. A non-flat region is, for example, an image region including an edge in a captured image, and is an image region in which a difference between values of pixels present close to each other is large.

More specifically, for example, the noise amount estimating unit 214 calculates a value indicating a variation in pixel values of an image region of a surrounding s×t pixels including the coordinates (i,j) of an interest pixel in a captured image. Hereinafter, the noise amount estimating unit 214 will be described as calculating a variance value as an example of the value indicating a variation in the pixel values. In the case where the calculated variance value is equal to or lower than a threshold set in advance, the noise amount estimating unit 214 extracts an image region of a surrounding s×t pixels including the coordinates (i,j) of the interest pixel as a flat region. On the other hand, in the case where the calculated variance value is larger than the threshold, the noise amount estimating unit 214 does not extract the image region of the surrounding s×t pixels including the coordinates (i,j) of the interest pixel as a flat region. The noise amount estimating unit 214 does not use an image region which has not been extracted as a flat region as a result of extraction of flat regions, that is, a non-flat region in the following processing. The noise amount estimating unit 214 can enhance the precision of estimating a noise amount by estimating a noise amount by using only an extracted flat region in the following processing.

Note that in the case where one set of data of captured images including a plurality of pieces of captured image data has been extracted in S501, the noise amount estimating unit 214 executes the following processing in S502. In this case, for example, the noise amount estimating unit 214 extracts a flat region from each of the plurality of pieces of captured image data extracted in S501 and sets a region common among the flat regions of the respective pieces of captured image data as a flat region of the set of data of captured images. In addition, for example, the noise amount estimating unit 214 may calculate variance values of pixel values in image regions each obtained by combining image regions composed of pixels at the same positions among a plurality of pieces of captured image data and extract an image region the calculated variance value of which is smaller than a predetermined value as a flat region. By determining a flat region in this way, it is possible to exclude an image region that has motion in captured images, that is, an image region that does not become flat temporally, from flat regions.

After S502, in S503, the noise amount estimating unit 214 calculates a noise amount in the flat region extracted in S502. For example, the noise amount estimating unit 214 calculates a value indicating a variation in pixel values of an image region of a surrounding r×q pixels including the coordinates (hi,hj) of any pixel in the flat region. Note that each of hi, hj, r, and q is any integer of 0 or more. Hereinafter, the noise amount estimating unit 214 will be described as calculating a standard deviation as an example of the value indicating a variation in the pixel values. Moreover, the noise amount estimating unit 214 calculates the above-mentioned standard deviation for each of all the pixels in the flat region extracted in S502, calculates a median of all the calculated standard deviations, and sets the calculated median as a noise amount, thereby calculating the noise amount.

Note that the method for calculating a noise amount is not limited to the above-mentioned method. For example, the noise amount estimating unit 214 may set not a median of standard deviations calculated for all pixels in a flat region but an average value of all the calculated standard deviations as a noise amount. In addition, for example, the noise amount estimating unit 214 may calculate a noise amount based on brightness values of pixels included in a flat region. Specifically, for example, the noise amount estimating unit 214 may calculate a standard deviation of brightness values of an image region of a surrounding r×q pixels including coordinates (hi,hj) of any pixel in a flat region and set the standard deviation of the brightness values included within a predetermined range as a noise amount.

After S503, in S504, the noise amount estimating unit 214 judges whether or not there is captured image data which has not been extracted in S501 yet and which is to be the target for the estimation processing of a noise amount among a captured image data group accumulated in the image buffer in S402. If it is judged that there is remaining captured image data in S504, the noise amount estimating unit 214 returns to the processing of S501 and repeatedly executes the processing from S501 to S504 until it is judged that there is no remaining captured image data in S504. Note that in this case, in S501, the noise amount estimating unit 214 extracts captured image data which has not been extracted in S501 yet and which is to be the target for the estimation processing of a noise amount from among the captured image data group accumulated in the image buffer in S402. If it is judged that there is no remaining captured image data in S504, the noise amount estimating unit 214 ends the processing of the flowchart shown in FIG. 5A, that is, the processing of S404.

FIG. 5B is a flowchart showing an example of a flow of processing of S405 in the noise amount determining unit 215 according to Embodiment 1. First, in S511, the noise amount determining unit 215 obtains results of estimating a noise amount estimated by the noise amount estimating unit 214 in S404, that is, results of calculating a plurality of noise amounts calculated by the noise amount estimating unit 214 in S503. Next, in S512, the noise amount determining unit 215 arranges the results of calculating the plurality of noise amounts obtained in S511 in order of time series based on times at which captured image data corresponding to the result of calculating each noise amount was obtained, and calculates a moving average of the noise amounts in time-series. For example, the noise amount determining unit 215 calculates a moving average of noise amounts by calculating a simple arithmetic mean of the noise amounts by using results of calculating noise amounts adjacent in order of time series. Note that the method for obtaining a moving average of noise amount is not limited to the above-mentioned method. For example, the noise amount determining unit 215 may calculate a moving average of noise amounts by calculating a weighted moving average of the noise amounts upon conducting weighting based on a difference in time interval between noise amounts adjacent in order of time series.

Next, in S513, the noise amount determining unit 215 determines a value of the moving average of the noise amounts calculated in S512 as the latest noise amount at the execution timing. Next, in S514, the noise amount determining unit 215 determines an adjustment parameter corresponding to the noise amount determined in S513 by referring to the above-mentioned look-up table, for example. Next, in S515, the noise amount determining unit 215 transmits the adjustment parameter determined in S514 to the adjustment parameter updating unit 216 as a new adjustment parameter. After S515, the noise amount determining unit 215 ends the processing of the flowchart shown in FIG. 5B, that is, the processing of S405. Note that although the above description has been made on the premise that a value of a moving average of calculated noise amounts is determined as the latest noise amount at the execution timing, the method for determining a noise amount is not limited to a method including calculating a moving average of noise amounts. For example, the noise amount determining unit 215 may calculate a statistic value indicating a tendency of a plurality of noise amounts such as an average value, a median, a mode, a minimum value, or a maximum value in results of calculating the plurality of noise amounts and determine the calculated statistic value as the latest noise amount at the execution timing.

As described above, in the present embodiment, the image processing apparatus 100 is configured to calculate noise amounts in a captured image data group obtained in order of time series and determine a noise amount at the execution timing based on the calculated noise amounts. Moreover, in the present embodiment, the image processing apparatus 100 is configured to determine a new adjustment parameter at the execution timing based on the determined noise amount and execute the image restoration processing by using the determined new adjustment parameter to generate data of a restored image 219. According to the image processing apparatus 100 configured as described above, it is possible to generate data of a restored image 219 in which degradation in the image quality has been sufficiently reduced without changing a network configuration of a learned CNN used in the image restoration processing.

### Modification 1 of Embodiment 1

Modification 1 of Embodiment 1 will be described. Although Embodiment 1 has been described on the premise that the execution timing is set in advance, the execution timing may be dynamically determined. For example, the image processing apparatus 100 further includes an execution timing determining unit, which is not shown in FIG. 2, as a functional configuration, and the execution timing determining unit determines an execution timing. For example, the execution timing determining unit may sequentially analyze time-series captured image data obtained by the image obtaining unit 211 and determine an execution timing for estimating a noise amount based on an amount of change in brightness of the captured images.

Specifically, for example, the execution timing determining unit first sets one or more local regions (also referred to as regions of interest (ROI)) for analyzing brightness in the captured image data obtained in S402. Subsequently, the execution timing determining unit calculates an average brightness of the set local region and holds a value of the calculated average brightness as a first average brightness. Subsequently, the execution timing determining unit also calculates an average brightness of local regions set in the same manner for captured image data obtained next in S402 and holds a value of the calculated average brightness as a second average brightness. Subsequently, the execution timing determining unit compares the first average brightness value and the second average brightness value. For example, in the case where a difference between the first average brightness value and the second average brightness value is equal to or more than a predetermined threshold, the execution timing determining unit determines that the timing is an execution timing, and the image processing apparatus 100 executes the estimation processing of a noise amount in S404. On the other hand, in the case where the difference between the first average brightness value and the second average brightness value is less than the threshold, the execution timing determining unit determines that the timing is not an execution timing, and the image processing apparatus 100 does not execute the estimation processing of a noise amount in S404.

Note that the above-mentioned local regions are preferably flat regions in a captured image. Hence, it is preferable that the execution timing determining unit set image regions which can be flat regions as local regions in a captured image. Image regions which can be flat regions may be set in advance by an instruction by the user, or the like, for example.

According to the image processing apparatus 100 configured as described above, it is possible to more efficiently set (determine) the execution timing for the estimation processing of a noise amount in S404 and the determination processing of a noise amount in S405. As a result, the number of times of the estimation processing of a noise amount in S404 and the determination processing of a noise amount in S405 can be reduced, and the total amount of calculation of the image processing apparatus 100 can be reduced.

### Modification 2 of Embodiment 1

Although the CNN for conducting the image restoration processing according to Embodiment 1 has been described as including the map generating layer, the intensity adjusting layer, and the image generating layer, this CNN may be a CNN composed of a plurality of CNNs. For example, this CNN is composed of a first CNN, a second CNN, and a third CNN, and the first CNN includes a map generating layer, the second CNN includes an intensity adjusting layer, and the third CNN includes an image generating layer. That is, in this case, a feature map is generated by the first CNN, a degradation restoration intensity is adjusted by the second CNN, and a restored image is generated by the third CNN.

For example, in the case where a CNN is composed of a plurality of CNNs as mentioned above, in the degradation restoration learning in the information processing apparatus 150, learning of the first CNN and the third CNN is conducted. In the case of such learning, the feature map outputted by the first CNN only have to be configured to be inputted into the third CNN. The image processing apparatus 100 obtains a weight parameter of the learned first CNN and a weight parameter of the learned third CNN from the information processing apparatus 150. In addition, in the degradation restoration inference in the image processing apparatus 100, the feature map outputted by the learned first CNN is configured to be inputted into the second CNN. In addition, a feature map obtained by multiplying each pixel value of the feature map by the coefficient α in the second CNN only have to be configured to be inputted to the learned third CNN.

Note that since the processing in the second CNN is merely processing of multiplying each pixel value of a feature map by the coefficient α, the second CNN does not necessarily have to be configured with a neural network.

### Embodiment 2

In Embodiment 1, an example of automatically updating an adjustment parameter for adjusting a degradation restoration intensity has been described. In Embodiment 2, a method in which the user manually sets and updates an adjustment parameter on a UI screen will be described. Note that in the following description, in the basic configurations and the like of the image processing system 1, description of the contents in common with the configurations of Embodiment 1 will be omitted and different matters will be mainly described.

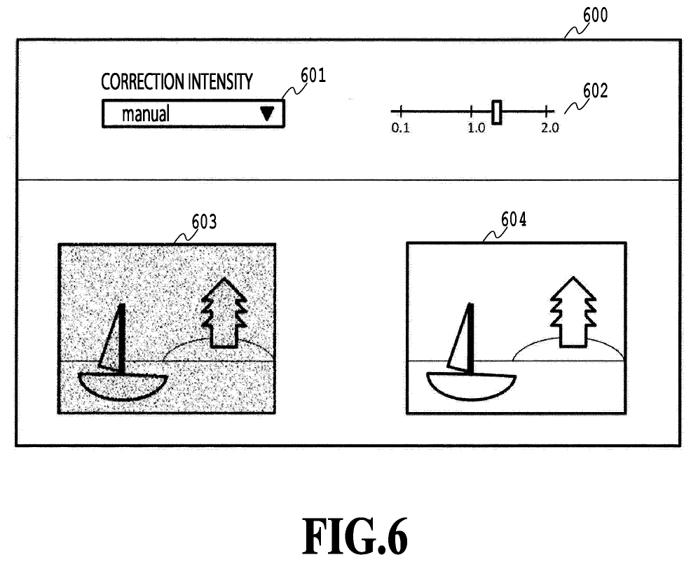

FIG. 6 is a diagram showing an example of a UI (user interface) screen 600 displayed on a display apparatus 40 according to Embodiment 2. The user can set a correction intensity by using the UI screen 600 shown as the example in FIG. 6. As the user sets the correction intensity, an adjustment parameter 218 corresponding to the set correction intensity is inputted into an image processing apparatus 100, and a parameter obtaining unit 212 obtains this. The image processing apparatus 100 executes the image restoration processing on captured image data by using the adjustment parameter 218 obtained by the parameter obtaining unit 212 to generate data of a restored image 219 in which degradation in the image quality has been restored.

A pull-down list box 601 is a UI component for selecting a mode for setting of an adjustment parameter in the image processing apparatus 100. For example, by the user selecting “manual” from among a pull-down list displayed in the pull-down list box 601, the image processing apparatus 100 is caused to operate in a mode in which an adjustment parameter is manually set by the user. In addition, by the user selecting “auto” from among the pull-down list displayed in the pull-down list box 601, the image processing apparatus 100 is caused to operate in a mode in which an adjustment parameter is automatically updated in the same manner as in the image processing apparatus 100 according to Embodiment 1. The items of the pull-down list displayed in the pull-down list box 601 to the user are not limited to only “manual” and “auto”. For example, the items of the pull-down list may contain various items such as a mode in which a fixed adjustment parameter set in advance is set, like “default”. Note that the UI screen 600 shown in FIG. 6 shows a state where “manual” has been selected from among the pull-down list displayed in the pull-down list box 601.

A slider bar 602 is a UI component for the user to select a value of a correction intensity for reducing degradation in the image quality. The slider bar 602 is in an active state that can receive the operation of the user in the state where “manual” has been selected in the pull-down list box 601. In the active state, it is possible to set the correction intensity through the operation from the user, and it is also possible to adjust the setting. A region 603 is a region in which a preview image of captured image data obtained by the image obtaining unit 211 is displayed. FIG. 6 shows a state where a preview image of a captured image in which a ship present on the sea as well as a land far away and a tree on the land are captured as subjects is displayed in the region 603 as an example. In addition, FIG. 6 shows a state where a preview image of a captured image in which noise has been added to the entire captured image is displayed in the region 603. For example, in the region 603, preview images of captured image data obtained by the image obtaining unit 211 in time series are sequentially displayed. By browsing preview images displayed in the region 603, the user can check the state of degradation in the image quality in captured images.

A region 604 is a region in which a preview image of a restored image 219 obtained as a result of the image restoration processing conducted on the captured image data obtained by the image obtaining unit 211 is displayed. In the region 604, time-series restored images 219 obtained as results of the image restoration processing conducted on the captured image data obtained by the image obtaining unit 211 in time series are sequentially displayed. By browsing preview images displayed in the region 604, the user can check how much degree the degradation in the image quality in the captured images, which were checked by browsing the preview images displayed in the region 603, have been restored.

According to the image processing apparatus 100 configured as described above, the user can set a correction intensity for degradation in the image quality in accordance with a use case upon checking the state of the degradation in the image quality in a captured image by browsing a preview image displayed in the region 603. For example, in the case where the user has selected “auto” or “default” as the operating mode of the image processing apparatus 100, the trouble for the user to manually set a correction intensity can be reduced. In addition, in the case where the user has selected “manual” as the operating mode of the image processing apparatus 100, the user can set image restoration processing in detail and can set a correction intensity for degradation in the image quality while checking the degree of restoration of the degradation in the image quality. As a result, it becomes possible to generate a restored image in which degradation in the image quality has been sufficiently reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc

According to the present disclosure, it is possible to generate a restored image in which degradation in the image quality has been sufficiently reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-136285, filed Aug. 24, 2023, which is hereby incorporated by reference herein in its entirety.

1. An image processing apparatus which generates data of a restored image to be obtained by reducing degradation in an image quality contained in an input image by a method of inference using a neural network, comprising:
one or more hardware processors; and
one or more memories storing one or more programs configured to be executed by the one or more hardware processors, the one or more programs including instructions for:
estimating a degree of the degradation in the image quality contained in the input image; and
determining an adjustment parameter to be used in image restoration processing of reducing the degradation in the image quality, based on the estimated degree of the degradation in the image quality.

2. The image processing apparatus according to claim 1, wherein the one or more programs further include instructions for:
extracting a flat region in which a variation of pixel values is small from the input image, based on a degree of variation of pixel values of a partial region of the input image, which includes an interest pixel in the input image; and
estimating the degree of the degradation in the image quality contained in the input image by estimating a degree of the degradation in the image quality contained in the extracted flat region.

3. The image processing apparatus according to claim 1, wherein the one or more programs further include instructions for:
obtaining data of the input images in time-series which are captured by an image capturing apparatus;
extracting data of the input image to be to be a target for estimation of the degree of the degradation in the image quality from among the data of the input images in time-series; and
estimating the degree of the degradation in the image quality in the extracted data of the input image to be the target.

4. The image processing apparatus according to claim 3, wherein the one or more programs further include instructions for:
extracting an input image data group including data of one or more of the input images as the data of the input image to be the target;
estimating a degree of the degradation in the image quality in the input image data group by estimating a degree of the degradation in the image quality in each of pieces of the data of the input images included in the extracted input image data group; and
determining the adjustment parameter based on the estimated degree of the degradation in the image quality in the input image data group.

5. The image processing apparatus according to claim 4, wherein the one or more programs further include instructions for:
extracting a plurality of the input image data groups;
estimating a degree of the degradation in the image quality in each of the extracted plurality of input image data groups; and
determining the adjustment parameter based on a plurality of the estimated degrees of the degradation in the image quality.

6. The image processing apparatus according to claim 5, wherein the one or more programs further include instructions for:
calculating a statistic value of at least one of a moving average, a weighted moving average, an average value, and a median of the plurality of estimated degrees of the degradation in the image quality; and
determining the adjustment parameter based on the calculated statistic value.

7. The image processing apparatus according to claim 5, wherein the one or more programs further include instructions for:
obtaining data of the input images in time-series which are captured by the image capturing apparatus;
obtaining an amount of change in brightness of the input images in time-series; and
in a case where the obtained amount of change satisfies a predetermined condition, conducting estimation processing of the degree of the degradation in the image quality contained in the input image.

8. The image processing apparatus according to claim 1, wherein
the neural network includes: a map generating layer, which includes one or more hidden layers and is used to generate a feature map representing an intensity of the image restoration processing on the data of the input image; and an image generating layer which includes one or more hidden layers and is used to generate the data of the restored image for the data of the input image,
the adjustment parameter corresponds to a coefficient by which each of pixel values of the feature map generated by the map generating layer is multiplied, and
the data of the restored image is generated by the image generating layer based on the data of the input image and the feature map after each pixel value of the feature map is multiplied by the coefficient.

9. The image processing apparatus according to claim 8, wherein the neural network further includes an intensity adjusting layer which includes one or more hidden layers and is used to multiply each pixel value in the feature map generated by the map generating layer by the coefficient based on the adjustment parameter.

10. The image processing apparatus according to claim 9, wherein the neural network is a learned model obtained as a result of learning in a state where a weight parameter of the intensity adjusting layer is fixed.

11. An image processing apparatus which generates data of a restored image to be obtained by reducing degradation in an image quality contained in an input image by a method of inference using a neural network, comprising:
one or more hardware processors; and
one or more memories storing one or more programs configured to be executed by the one or more hardware processors, the one or more programs including instructions for:
setting a degree of reducing the degradation in the image quality contained in the input image; and
generating image data representing the input image having a reduced degradation in the image quality in accordance with the set degree.

12. An image processing method for generating data of a restored image to be obtained by reducing degradation in an image quality contained in an input image by a method of inference using a neural network, comprising the steps of:
estimating a degree of the degradation in the image quality contained in the input image; and
determining an adjustment parameter to be used in image restoration processing of reducing the degradation in the image quality, based on the estimated degree of the degradation in the image quality.

13. A non-transitory computer readable storage medium storing a program for causing a computer to perform a control method of an image processing apparatus which generates data of a restored image to be obtained by reducing degradation in an image quality contained in an input image by a method of inference using a neural network, the control method comprising the steps of:
estimating a degree of the degradation in the image quality contained in the input image; and
determining an adjustment parameter to be used in image restoration processing of reducing the degradation in the image quality, based on the estimated degree of the degradation in the image quality.
